(19) United States
(12) Patent Application Publication
(10) Pub. No.: US 2003/0208444 A1
(43) Pub. Date: Nov. 6, 2003

(54) Payment system and method

(76) Inventor: Hermann Sauer, Eltville (DE)

Correspondence Address: BAKER BOTTS L.L.P., 2001 ROSS AVENUE, SUITE 600, DALLAS, TX, 75201-2980, US

(21) Appl. No.: 10/140,403

(22) Filed: May 6, 2002

(51) Int. Cl. G06F 17/60

(52) U.S. Cl. 705/40

(57) ABSTRACT

A payment system and method are disclosed, whereby a user can order content or services via the Internet using a mobile radiotelephone. The mobile phone can be coupled to the content or service provider via the Internet (e.g., using the Wireless Application Protocol). The user can be billed for the purchased content or service(s) in the bill for the mobile phone.

### TECHNICAL FIELD OF THE INVENTION

The present invention relates in general to electronic commerce and, in particular, but not exclusively, to a system and method for facilitating payments via the Internet.

### BACKGROUND OF THE INVENTION

With the rapidly increasing sales of intangible goods (e.g., information or content) via the Internet, the costs for processing payments using conventional methods have become more expensive than the goods involved. Electronic payments are a relatively new form of payment by which the information or services being offered (e.g., via the Internet) are metered out and charged in relatively small increments. Currently, in the Internet environment, electronic payments can be made for conventional telephone charges, automatic toll charges, and certain digital cash applications.

Providers of content (e.g., text, images, multimedia) are growing more and more anxious to be able to charge users according to the value of the content being supplied (value-based billing). On the other hand, the users of the content are demanding that the providers offer more secure, reliable, and convenient payment and delivery systems, but with minimal or no transaction costs incurred. Currently, there are approximately 50 payment systems being offered, including for example, the Paybox® and Jamba® payment systems. However, because of existing payment security, reliability, and convenience concerns, these offerings have yet to gain user acceptance. Furthermore, existing requirements for Internet transaction payment systems are subscription-based, which at the outset, imposes a significant cost threshold on potential users. These existing payment approaches serve to stifle user responsiveness in terms of purchasing goods and services via the Internet. Accordingly, a significant need exists for a payment system and method that allows content providers to charge according to the value of the content supplied, and also provides secure, reliable and convenient payment and delivery systems with minimal transaction costs incurred.

### SUMMARY OF THE INVENTION

According to the present invention, problems and disadvantages associated with previous techniques for facilitating payments may be reduced or eliminated.

Essentially, in accordance with the present invention, a method and system for processing payments is provided, whereby an independent third party for processing payments can be introduced between a mobile network operator, a content provider, and a bank. As a result, the method and system for processing payments can provide interoperability between all connected content providers and network operators.

According to one example embodiment of the present invention, a user can order content using a mobile radiotelephone. The mobile phone is coupled to the content provider via the Internet (e.g., using the Wireless Application Protocol). The user can be billed for the purchased content via the bill for the mobile phone. The network operator can thereby assume the role of a bank.

An important technical advantage of the present invention is that a method and system for processing payments are provided, whereby purchasers can be charged according to the value of the content provided.

Another important technical advantage of the present invention is that a method and system for making payments provides a secure, reliable, and convenient payment and delivery channel.

Still another important technical advantage of the present invention is that a method and system for making payments are provided, which incurs minimal transaction costs for users.

Yet another important technical advantage of the present invention is that a method and system for making payments are provided, whereby an end user can be authenticated in real-time, which allows for an immediate transfer of funds from one entity to another. As such, the authentication function of a mobile network operator can be introduced for other contexts, such as for example, stationary Internet, interactive TV, and point of sale.

Other technical advantages of the present invention will be readily apparent to one skilled in the art from the following figures, description and claims.

### BRIEF DESCRIPTION OF THE DRAWINGS

For a more complete understanding of the present invention and its advantages, reference is now made to the following descriptions, taken in conjunction with the accompanying drawings, in which:

FIG. 1 illustrates an example system, which can be used to implement payments, in accordance with one example embodiment of the present invention;

FIG. 2 illustrates an example method, which can be used to implement one example embodiment of the present invention;

FIG. 3 illustrates an example system, which can be used to implement payments, in accordance with a second example embodiment of the present invention; and

FIG. 4 illustrates an example method, which can be used to implement a second example embodiment of the present invention.

### DETAILED DESCRIPTION OF THE INVENTION

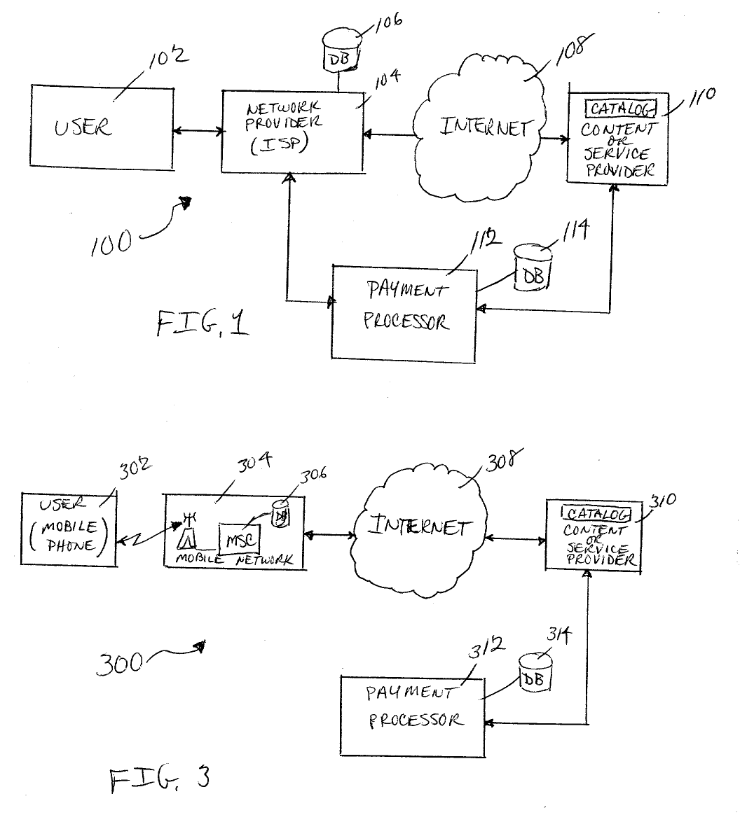

The preferred embodiment of the present invention and its advantages are best understood by referring to FIGS. 1-4 of the drawings, like numerals being used for like and corresponding parts of the various drawings.

FIG. 1 illustrates an example system 100, which can be used to implement payments, in accordance with one example embodiment of the present invention. For this example embodiment, system 100 can include an Internet Service Provider's (ISP's) authentication server 104. A primary function of authentication server 104 is to allow a user 102 to send or receive content over or from the Internet 108 using a typical user interface language such as, for example, the HyperText Markup Language (HTML). Web server 110 can accept a request for content from user 102 via a web browser (e.g., Microsoft Internet Explorer or Netscape Navigator). For example, web server 110 can be implemented using a Microsoft Internet Information Server (IIS).

Also for this example embodiment, system 100 can include a payment processor unit 112. A primary function of payment processor unit 112 is to administer user authentication information, and process payment information between user 102 and a content or service provider 110. Payment processor unit 112 can be a digital processor, or any suitable digital processing device capable of executing application software for administering user authentication information and/or processing payment information between user 102 and content or service provider 110. For example, payment processor unit 112 can be a server. A first database (or suitable data storage area) 106 is associated with the network gateway's authentication server 104, and a second database (or suitable data storage area) 114 is associated with payment processor unit 112.

FIG. 2 illustrates an example method 200, which can be used to implement one example embodiment of the present invention. For this embodiment, method 200 can be implemented with the network provider's authentication server (e.g., 104) coupled to payment processor unit 112 (e.g., via a suitable telecommunications connection), as shown in FIG. 1. At step 202 of method 200, a user (e.g., user 102) can log in to the Internet 108 via a network provider (e.g., through authentication server 104). At step 204, using a suitable browser, user 102 can navigate the Internet 108 to a web page for content/service provider 110. For this example, the web page for content/service provider 110 can include a link to a catalog of content or services, which can be available for user 102 to purchase from provider 110. At step 206, user 102 can view the catalog (e.g., using the browser) and select a service or content item for purchase.

At step 208, in response to the user's request for purchase, content/service provider 110 can convey a request to payment processor unit 112, which asks payment processor unit 112 to vouch for the user and the purchase transaction. Also, primarily for authentication purposes, the conveyed request can include an Internet Protocol (IP) address for the device associated with user 102 (or other suitable network address for user 102). At step 210, payment processor unit 112 can determine to what network provider is the user connected. For example, payment processor unit 112 can make this determination by querying each network provider to which it is coupled (e.g., the ISP associated with server 104). The query can include the user's IP address. For this example, the ISP can search for pertinent information included in associated database 106 for user 102 (e.g., using the IP address provided by payment processor unit 112). This query can be simplified by using lists of IP addresses, which can be maintained within the payment system infrastructure. As another example, payment processor unit 112 can search its own associated database 114 for pertinent information about user 102. In this case, database 114 can include pertinent user information for each network provider coupled to payment processor 112.

If the user making the purchase (e.g., 102) can be associated with a network provider, at step 212, payment processor unit 112 can “vouch for” or authenticate that user's relationship with that network provider in that regard. At step 214, payment processor unit 112 conveys a request to the billing system for the network provider involved (e.g., 104), which asks the billing system to vouch for (or stand behind) the user's purchase request. At step 215, if the network provider's billing system vouches for the user's purchase request, at step 216, payment processor unit 112 can convey a message to the content/service provider 110, whereby payment processor unit 112 can vouch for the user's purchase request. At step 218, content/service provider 110 can display a request to user 102 (e.g., with the user's browser via the Internet), which asks the user if payment for the purchase can be made by the user's phone bill from network provider 104. At step 219, if the user confirms (e.g., using the browser) to the content/service provider that the phone bill can be used for payment, at step 220, content/service provider 110 can release the purchased content or services for user 102. At step 222, content/service provider 110 conveys a demand to payment processor unit 112 to bill user 102 for the released content or services. At step 224, payment processor unit 112 can convey pertinent billing event information for user 102 to the associated network provider (e.g., 104). At step 226, the user's network provider can request payment for purchased content or services from the user in the user's telephone bill. At step 228, at regular intervals (e.g., at the end of each month), payment processor unit 112 can convey payment clearance information to each network provider (e.g., 104) which can inform the network provider(s) what payments are to be released to which content/service provider (e.g., 110).

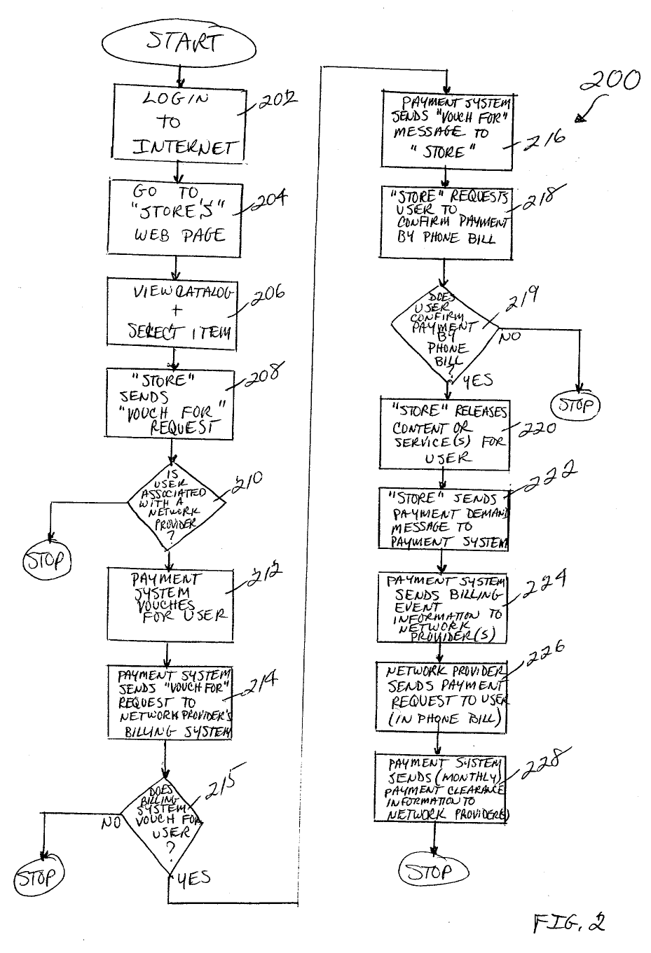

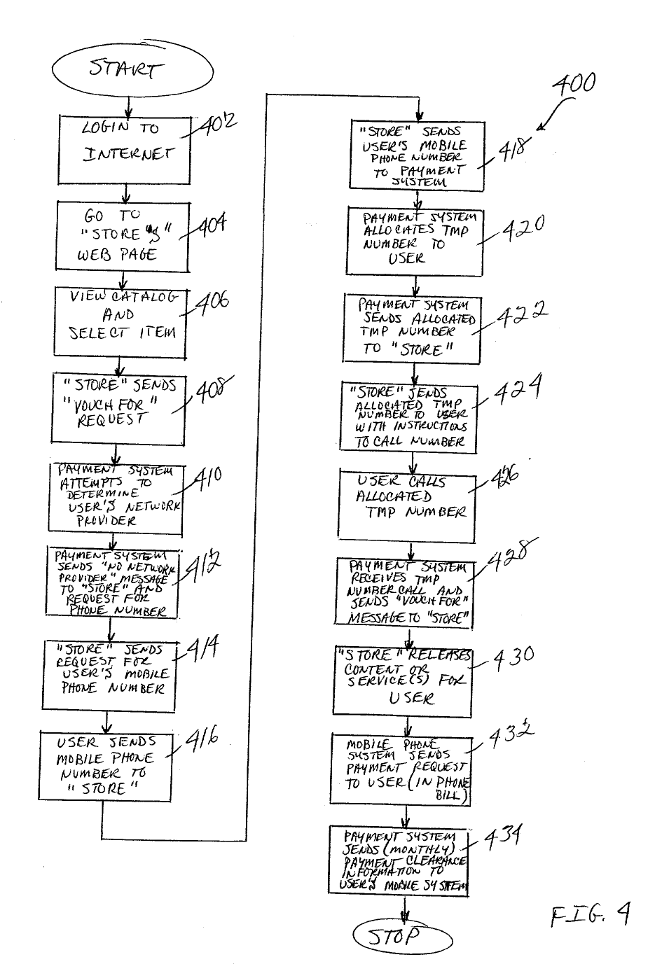

FIG. 3 illustrates an example system 300, which can be used to implement payments, in accordance with a second example embodiment of the present invention. In this case, a user may access some type of content without using a mobile phone to gain access. When a user desires to purchase a good or service that is accessed via a web browser of the user's personal computer, some action can be necessary in order to establish a relationship between the user's mobile device and an (e.g., anonymous) web surfer. For example, this action can be a phone call that sends a specific Short Message Service (SMS) message, or dialing an Unstructured Supplementary Service Data (USSD) service number with a mobile phone.

For this example embodiment, system 300 can include a mobile radiotelephone system 304. A primary function of mobile system 304 is to allow a user 302 to send or receive content over or from the Internet 308 using a mobile radiotelephone (e.g., cellular phone). Mobile system 304 can enter a request for content from user 302. For example, this request can be made via mobile system 304 using the Wireless Application Protocol (WAP).

Also for this example embodiment, system 300 can include a payment processor unit 312. A primary function of payment processor unit 312 is to administer user authentication information, and process payment information between user 302 and a content or service provider 310. Payment processor unit 312 can be a digital processor, or any suitable digital processing device capable of executing application software for administering user authentication information and/or processing payment information between user 302 and content or service provider 310. For example, payment processor unit 312 can be a server. A first database (or suitable data storage area) 306 is associated with mobile system 304, and a second database (or suitable data storage area) 314 is associated with payment processor unit 312.

FIG. 4 illustrates an example method 400, which can be used to implement a second example embodiment of the present invention. For this embodiment, method 400 can be used to implement example system 300 shown in FIG. 3 (e.g., without a network provider being coupled to payment processor unit 312). At step 402 of method 400, a user (e.g., user 302) can log in to the Internet 308 via a wireless provider (e.g., through mobile system 304 using the WAP). At step 404, using the mobile phone, user 302 can navigate the Internet 308 to a web page for content/service provider 310. For this example, the web page for content/service provider 310 can include a link to a catalog of content or services, which can be available for user 302 to purchase from provider 310. At step 406, user 302 can view the catalog (e.g., using the wireless phone's display) and select a service or content item for purchase.

At step 408, in response to the user's request for purchase, content/service provider 310 can convey a request to payment processor unit 312, which asks payment processor unit 312 to vouch for the user and the purchase transaction. Also, primarily for authentication purposes, the conveyed request can include an Internet Protocol (IP) address for the device (e.g., cell phone) associated with user 302 (or other suitable network address for user 302). At step 410, payment processor unit 312 attempts to determine to what wireless system the user is connected.

At step 412, payment processor unit 312 conveys a message to content/service provider 310, which informs this provider that there is no network provider for the purchasing user coupled to payment processor unit 312. Also, in the same message or a separate message, payment processor unit 312 can request content/service provider 310 to obtain a mobile telephone number from the user. At step 414, the content/service provider conveys a request (e.g., via the Internet and the user's wireless phone) for the user to enter a valid mobile telephone number on-line. At step 416, in response to the request for a mobile telephone number, the user can enter the number on the content/service provider's web page (e.g., with the user's wireless phone). At step 418, content/service provider 310 can convey a message to payment processor unit 312, which message includes the mobile telephone number entered by the user.

At step 420, payment processor unit 312 can allocate a Transaction Mobile Payment (TMP) telephone number for this user's purchase transaction. For example, payment processor unit 312 can allocate a TMP number retrieved from a managed telephone list (e.g., stored in database 314). At step 422, payment processor unit 312 can convey the allocated TMP number for this user and purchase request in a message to content/service provider 310. At step 424, content/service provider 310 can convey this TMP number to user 302 in a message (e.g., via the Internet 308), which message also can request user 302 to call the TMP number in order to commit to payment of the purchase amount on the user's mobile telephone bill.

At step 426, the user can dial the TMP number using the mobile telephone. At step 428, upon answering the user's TMP number phone call, payment processor unit 312 can convey a message to content/service provider 310, which informs the content/service provider that the user has dialed the allocated TMP number. Also, in the same or a different message, payment processor unit 312 can confirm for the content/service provider that payment processor unit 312 can vouch for the user's requested purchase. At step 430, content/service provider 310 can release the content or service(s) purchased to user 302. At step 432, the user's mobile telephone network provider 304 can request payment for the purchased content or services from the user in the user's telephone bill. At step 434, at regular intervals (e.g., at the end of each month), payment processor unit 312 can convey payment clearance information to each mobile telephone network provider which can inform them what payments are to be released to which content/service provider (e.g., 310). For example, payment processor unit 312 can determine which mobile telephone network provider is associated with a particular user by searching database 314 for the user's telephone number (or the user's IP address for the mobile phone). Database 314 can include a mapping of users and their mobile telephone numbers to mobile network providers.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims.

What is claimed is:

1. A method for facilitating payments via a telecommunications network, comprising the steps of:
receiving a purchase request from a user;
sending a vouch for request associated with said purchase request to a network provider associated with said telecommunications network;
determining if said network provider vouches for said user;
if said network provider vouches for said user, releasing an item or service associated with said purchase request; and
said network provider requesting payment from said user for said released item or service associated with said purchase request.

2. The method of claim 1, wherein said telecommunications network comprises an Internet.

3. The method of claim 1, wherein said network provider comprises an Internet Service Provider (ISP).

4. The method of claim 1, wherein the receiving step comprises the step of:
a content or service provider receiving said purchase request from said user via an Internet.

5. The method of claim 1, wherein the sending step comprises the steps of:
a content or service provider sending a vouch for request associated with said purchase request to a payment system; and
said payment system sending said vouch for request to said network provider associated with said telecommunications network.

6. The method of claim 1, wherein the determining step comprises the steps of:
a payment system determining if said user is associated with said network provider; and
if said user is associated with said network provider, determining if said network provider vouches for said user.

7. The method of claim 1, wherein the step of said network provider requesting payment from said user comprises the step of:
said network provider sending a bill to said user, said bill including a charge for said released item or service associated with said purchase request.

8. A method for facilitating payments via a telecommunications network, comprising the steps of:
sending a purchase request f or an item or service via a wireless communications unit and said telecommunications network;
determining if said user is associated with a network provider for said telecommunications network;
if said user is not associated with a network provider for said telecommunications network, requesting identification information associated with said wireless communications unit from said user;
if said user responds to said request for identification information, allocating a transaction phone number associated with said user and said purchase request;
if a phone call for said transaction phone number is received, releasing an item or service associated with said purchase request; and
requesting payment from said user for said released item or service associated with said purchase request.

9. The method of claim 8, wherein the requesting payment step comprises the step of:
a wireless communications network provider requesting said payment from said user.

10. The method of claim 8, wherein said telecommunications network comprises an Internet.

11. The method of claim 8, wherein said network provider comprises an Internet Service Provider (ISP).

12. The method of claim 8, wherein the receiving step comprises the step of:
a content or service provider receiving said purchase request from said user via a mobile radiotelephone network and an Internet.

13. The method of claim 8, wherein said identification information comprises a mobile radiotelephone number.

14. The method of claim 8, wherein the determining step comprises the steps of:
a payment system determining if said user is associated with said network provider.

15. The method of claim 8, wherein the step of requesting payment from said user comprises the step of:
a wireless communications network provider sending a bill to said user, said bill including a charge for said released item or service associated with said purchase request.

16. A system for facilitating payments via a telecommunications network, comprising:
a first processing unit associated with a network provider;
a second processing unit coupled to said first processing unit, said second processing unit associated with a content or service provider; and
a payment processor unit, said first and second processing units coupled to said payment processor unit, wherein said first and second processing units and said payment processor unit are operable, in combination, to:
receive a purchase request from a user;
send a vouch for request associated with said purchase request to a network provider associated with said telecommunications network;
determine if said network provider vouches for said user;
release an item or service associated with said purchase request if said network provider vouches for said user; and
request payment from said user for said released item or service associated with said purchase request.

17. The system of claim 16, wherein said telecommunications network comprises an Internet.

18. The system of claim 16, wherein said network provider comprises an Internet Service Provider (ISP).

19. The system of claim 16, wherein said second processing unit is further operable to:
receive said purchase request from said user via an Internet.

20. The system of claim 16, wherein said second processing unit and said payment processor unit are further operable to:
send a vouch for request associated with said purchase request to said network provider associated with said telecommunications network.

21. The system of claim 16, wherein said payment processor unit if further operable to:
determine if said user is associated with said network provider; and
determine if said network provider vouches for said user if said user is associated with said network provider.

22. The system of claim 16, wherein said first processing unit is further operable to:
send a bill to said user, said bill including a charge for said released item or service associated with said purchase request.

23. A system for facilitating payments via a telecommunications network, comprising:
a wireless telecommunications network coupled to said telecommunications network;
a first processing unit associated with said wireless telecommunications network;
a second processing unit coupled to said first processing unit, said second processing unit associated with a content or service provider; and
a payment processor unit, said second processing unit coupled to said payment processor unit, wherein said first and second processing units and said payment processor unit are operable, in combination, to:
send a purchase request for an item or service via said first processing unit and said telecommunications network;
determine if said user is associated with a network provider for said telecommunications network;
request identification information associated with said wireless communications unit from said user if said user is not associated with a network provider for said telecommunications network;
allocate a transaction phone number associated with said user and said purchase request if said user responds to said request for identification information;
release an item or service associated with said purchase request if a phone call for said transaction phone number is received; and
request payment from said user for said released item or service associated with said purchase request.

24. The system of claim 23, wherein said second processing unit is further operable to:
request said payment from said user.

25. The system of claim 23, wherein said telecommunications network comprises an Internet.

26. The system of claim 23, wherein said network provider comprises an Internet Service Provider (ISP).

27. The system of claim 23, wherein said second processing unit is further operable to:
receive said purchase request from said user via a mobile radiotelephone network and an Internet.

28. The system of claim 23, wherein said identification information comprises a mobile radiotelephone number.

29. The system of claim 23, wherein said payment processor unit is further operable to:
determine if said user is associated with said network provider.

30. The system of claim 23, further comprising:
a wireless communications network operable to:
send a bill to said user, said bill including a charge for said released item or service associated with said purchase request.

31. Software for facilitating payments via a telecommunications network, the software embodied in computer-readable media and when executed operable to:
receive a purchase request from a user;
send a vouch for request associated with said purchase request to a network provider associated with said telecommunications network;
determine if said network provider vouches for said user;
release an item or service associated with said purchase request if said network provider vouches for said user; and
request payment from said user for said released item or service associated with said purchase request.

32. Software for facilitating payments via a telecommunications network, the software embodied in computer-readable media and when executed operable to:
send a purchase request for an item or service via a wireless communications unit and said telecommunications network;
determine if said user is associated with a network provider for said telecommunications network;
request identification information associated with said wireless communications unit from said user if said user is not associated with a network provider for said telecommunications network;
allocate a transaction phone number associated with said user and said purchase request if said user responds to said request for identification information;
release an item or service associated with said purchase request if a phone call for said transaction phone number is received; and
request payment from said user for said released item or service associated with said purchase request.
